(19) United States
(12) Patent Application Publication
(10) Pub. No.: US 2025/0209793 A1
(43) Pub. Date: Jun. 26, 2025

(54) Method and Apparatus, Device, Vehicle, and Medium for Generating Classification Model

(71) Applicant: Robert Bosch GmbH, Stuttgart (DE)

(72) Inventors: Xiangyu Bao, Wuxi, Jiangsu (CN); Yiwen Zhang, Wuxi, Jiangsu (CN); Ma Fu, Suzhou, Jiangsu (CN); Wenhuan Duan, Suzhou, Jiangsu (CN)

(21) Appl. No.: 18/981,564

(22) Filed: Dec. 15, 2024

(30) Foreign Application Priority Data
Dec. 22, 2023 (CN) 2023 1178 9196.2

(51) Int. Cl. G06V 10/764; G06V 10/32; G06V 10/74; G06V 10/774; G06V 10/776; G06V 20/56

(52) U.S. Cl. CPC G06V 10/764; G06V 10/32; G06V 10/761; G06V 10/774; G06V 10/776; G06V 20/56

(57) ABSTRACT

A method and an apparatus, a device, a vehicle, and a medium for generating a classification model are disclosed. The method for generating a classification model includes (i) acquiring, by a text-image semantic alignment model, a plurality of images associated with a target text, which is indicative of a target scene, (ii) generating an image sample set comprising an image sample labeled with a category by determining which category each of the plurality of images belongs to, and (iii) generating a classification model for the target scene based on the image sample set, wherein the generation of the classification model is based on a pre-trained model utilizing linear probing. In this way, customized classification models can be quickly generated for specific scenes to suit actual needs, providing improved flexibility and accuracy while ensuring the efficiency and stability of the model generation process.

This application claims priority under 35 U.S.C. § 119 to patent application no. CN 2023 1178 9196.2, filed on Dec. 22, 2023 in China, the disclosure of which is incorporated herein by reference in its entirety.

Examples of the present disclosure relate generally to the computer field, and in particular to method and apparatus, devices, vehicles, and media for generating a classification model.

### BACKGROUND

Object detection is a computer vision technique that can be used to locate and identify vehicles, pedestrians, road signs, etc. in visual information, such as images and videos. Such techniques enable vehicle driving systems (such as Advanced Driving Assistance Systems (ADAS) and Autonomous Driving (AD) systems) to better understand the driving environment to make safer, more effective decisions and take appropriate action.

Object detection of vehicles is an important part of assisted driving and autonomous driving techniques. It provides an important basis for decision-making on driving systems by detecting and identifying key objects in the driving process through techniques such as image recognition and machine learning. As computer vision and machine learning technology continue to improve, the accuracy and real-time reliability of vehicle object detection have also been continuously improved.

### SUMMARY

Examples of the present disclosure provide a method and an apparatus, a device, and a medium for generating a classification model.

According to a first aspect of the present disclosure, a method for generating a classification model is provided. The method includes acquiring, by a text-image semantic alignment model, a plurality of images associated with a target text that indicates a target scene. The method further comprises generating an image sample set comprising an image sample labeled with a category by determining which category each image of the plurality of images belongs to. The method further comprises generating the classification model for the target scene based on the image sample set, wherein the generation of the classification model is based on a pre-trained model using linear probing.

According to a second aspect of the present disclosure, an apparatus for generating a classification model is provided. The device includes an image acquisition module configured to acquire a plurality of images associated with a target text through a text-image semantic alignment model, the target text indicating a target scene. The apparatus further comprises a sample set generation module, which is configured to generate an image sample set comprising an image sample labeled with a category by determining which category each image of the plurality of images belongs to. The apparatus also includes a model generation module configured to generate the classification model for the target scene based on the image sample set, the classification model being a pre-trained model using linear probing.

According to a third aspect of the present disclosure, an electronic device is provided. The electronic device includes at least one processor. The electronic device further comprises a memory coupled to the at least one processor and having instructions stored thereon, and the instructions, when executed by the at least one processor, cause the device to perform the method according to the first aspect of the present disclosure.

According to a fourth aspect of the present disclosure, a vehicle is provided. The vehicle includes the electronic device according to the third aspect of the present disclosure.

According to a fifth aspect of the present disclosure, a computer-readable storage medium is provided. The computer-readable storage medium has computer-executable instructions stored thereon, wherein the computer-executable instructions are executed by a processor to implement the method according to the first aspect of the present disclosure.

### BRIEF DESCRIPTION OF THE DRAWINGS

The exemplary examples of the present disclosure will be described in further detail in conjunction with accompanying drawings in order to further clarify the above-mentioned and other objectives, features and advantages of the present disclosure, wherein in the exemplary examples of the present disclosure, the same or similar reference numerals typically represent the same or similar parts, components, etc.

FIG. 1 illustrates a schematic diagram of an exemplary environment in which the method and/or apparatus according to examples of the present disclosure may be implemented;

FIG. 2 illustrates a flow chart for generating a classification model according to examples of the present disclosure;

FIG. 3 illustrates a diagram of a classification model generation process according to examples of the present disclosure;

FIG. 4 illustrates a diagram of search processing for an image set according to examples of the present disclosure;

FIG. 5 illustrates generation processing of an image sample set according to examples of the present disclosure;

FIG. 6 illustrates training processing of a classification model according to examples of the present disclosure;

FIG. 7 illustrates test processing of a classification model according to examples of the present disclosure;

FIG. 8 illustrates prediction processing of a classification model according to examples of the present disclosure;

FIG. 9 shows a schematic diagram of an apparatus for generating a classification model according to examples of the present disclosure; and

FIG. 10 illustrates a schematic block diagram of an exemplary device according to an example that is suitable to embody the content of the present disclosure.

In the various accompanying drawings, the same or corresponding numbers represent the same or corresponding portions.

### DETAILED DESCRIPTION

The examples of the present disclosure will be described in further detail below with reference to the accompanying drawings. While certain examples of the present disclosure are illustrated in the accompanying drawings, it should be understood that the present disclosure may be implemented in various forms and should not be construed as being limited to the examples set forth herein. Rather, these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and its variations should be understood as open-ended inclusion; that is, “comprising but not limited to.” The term “based on” should be understood as “at least partially based on.” The term “one example” or “the example” should be understood as “at least one example.” The term “first,”, “second,” etc. may refer to different or the same objects unless expressly indicated otherwise.

As noted above, vehicle object detection functionality helps improve the performance of the ADAS and autonomous driving AD systems. Through techniques such as image recognition and machine learning, key objects in the driving environment (such as vehicles, pedestrians, and road signs) are identified to better understand the driving environment so that the corresponding ADAS or AD system can make safer and more effective decisions and take appropriate action.

Object detection for a vehicle may be based on neural networks or other machine learning models (e.g., convolutional neural networks, reverse-propagation neural networks, etc.) that have the ability to extract useful features from visual information such as images and videos and utilize these extracted features to identify key objects. Building a well-performing model requires a large amount of high-quality data, and therefore it is necessary to obtain as much valuable data as possible using appropriate data mining strategy, which is critical to both the precision and generalization capabilities of the model.

Although the data mining strategy for vehicle object detection has been developed in recent years as an integral part of the development of ADAS or AD system, the current data mining solution still has some problems, resulting in its failure to fully meet the needs of vehicle object detection, such as insufficient accuracy and generalization capabilities.

Traditional solutions manually search for raw data and perform manual marking on the searched data to form a sample set before training the model with the manually generated sample set. Such a raw data search process and sample set establishment process may not be able to effectively process large scale and diverse data. Typically, the amount of data required for vehicle object detection is very large, and the data covers a variety of different scenes (such as tunnels and highways) and conditions (such as weather conditions and road congestion conditions). Because manual searching and marking speed are slow, it is time and effort consuming and does not guarantee consistency and stability. In addition, it is inevitable that there are false marks and missed samples when relying only on labor. Moreover, traditional model generation involves full tuning of most or even all parameters of the model, resulting in a lengthy process without contributing to precision and robustness.

To address at least the above and other potential problems, the examples of the present disclosure provide a scheme for generating a classification model. The scheme for generating a classification model according to examples of the present disclosure includes acquiring, by a text-image semantic alignment model, a plurality of images associated with a target text indicating a target scene. The scheme also includes generating an image sample set including an image sample labeled with a category by determining the category of each image of the plurality of images. The scheme also includes generating a classification model for the target scene based on the image sample set, wherein the generation of the classification model is based on a pre-trained model utilizing linear probing. In this way, customized classification models can be quickly generated for specific or concrete scenarios to suit actual needs, providing improved flexibility and accuracy while ensuring the efficiency and stability of the model generation process.

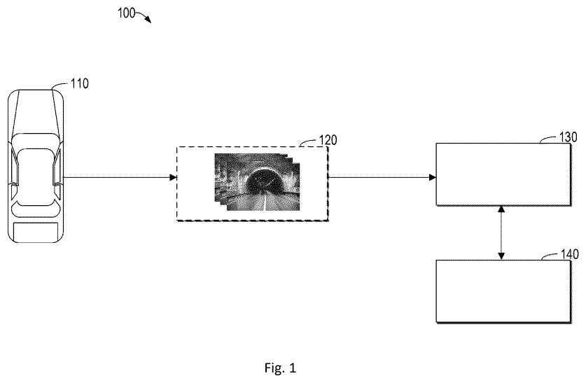

FIG. 1 illustrates a schematic diagram of an exemplary environment 100 in which the method and/or process according to examples of the present disclosure may be implemented. As shown in FIG. 1, the exemplary environment 100 may include a vehicle 110, an image set 120, a computing device 130, and a memory device 140, and these components may be coupled to each other for interaction, as shown in FIG. 1. It will be understood that limited components are shown in the exemplary environment 100 for implementing the examples of the present disclosure for the purpose of ease of understanding and illustration only, and the examples of the present disclosure are not so limited. For example, the exemplary environment 100 may also include a display (not shown) that is configured to display a classification result.

According to an example of the present disclosure, the vehicle 110 may be any type of motorized or non-motorized vehicle capable of carrying a person and/or item and movable. The vehicle 110 typically includes one or more wheels, one or more seats, one or more carrier structures (such as carriages and cabins), one or more power systems (such as engines and motors), one or more control systems (such as steering wheels and acceleration pedals), and one or more security systems (such as seat belts and airbags), etc.

As shown in FIG. 1, the vehicle 110 is illustrated as a car. However, this is merely exemplary and non-limiting. By way of example, the vehicle 110 may include, but is not limited to, a bus, a truck, an off-road vehicle, a sports car, a motorcycle, etc. Further, the vehicle 110 may be based on fossil energy or clean energy or a combination thereof. Fossil energy-based vehicles mainly refer to vehicles that use fossil fuels such as oil and natural gas as a source of power, such as conventional gasoline vehicles and fuel trucks. Clean energy-based vehicles refer to vehicles that use clean energy as a source of power, such as electric vehicles, hydrogen fuel cell vehicles, and solar vehicles.

According to an example of the present disclosure, the vehicle 110 may include a plurality of sensors for a specific driving function such as an autonomous or assisted driving function. These sensors may work in conjunction with the computing device 130 to provide accurate perception and decision control of the environment surrounding the vehicle 110. The plurality of sensors included in the vehicle 110 may include a visual sensor (e.g., a camera, an infrared sensor, a depth sensor, etc.) for capturing an image set 120 indicating the driving environment and scene of the vehicle 110 during the driving process.

According to an example of the present disclosure, the image set 120 may include images indicating various different scenes and conditions, etc., of the vehicle 110 in the course of driving. Examples of such scenes may include, but are not limited to, tunnels, intersections, stand-offs, etc. The image set 120 may be stored in the storage device 140 and accessed by the computing device 130. In some examples, the image set 120 may be presented in the form of a video including image frames. As discussed above, images in the image set 120 may be taken from a visual sensor on the vehicle 110, such as a camera, an infrared sensor, and a depth sensor, and the images in the image set 120 may therefore include red, green, blue (RGB) images, infrared images, and depth images, etc. It will be understood that this is not limiting and that images in the image set 120 can also be obtained in other ways, such as through data-enhancing processing. Further, examples of the present disclosure do not limit the size and format of the images, and it is sufficient to adopt appropriate size and format as needed.

According to an example of the present disclosure, the computing device 130 may include an in-vehicle computing device, an out-of-vehicle computing device, and a combination thereof. The computing device 130 may have computational capabilities and is configured to be generated to perform a classification model generation according to examples of the present disclosure. During execution of the classification model generation according to the examples of the present disclosure, the computing device 130 may access the memory device 140 and perform corresponding calculations. It will be understood that the computing device 130 is shown as a computing device in FIG. 1, but this is only schematic and non-limiting, and the exemplary environment 100 may also contain a greater number of computing devices. The corresponding operations of the computing device 130 will be described in further detail below.

By way of example and not limitation, the computing device 130 may include, but is not limited to, a personal computer, a laptop computer, a server computer, a mobile device (such as smart phones and tablets), a wearable electronics device, a multimedia player, a personal digital assistant (PDA), a smart home device, consumer electronics, or a distributed computing environment that includes any one or more of the above devices.

According to an example of the present disclosure, the memory device 140 may be configured to store an image set 120 from the vehicle 110, a model to be used on the computing device 130 and parameters and a classification result thereof. It will be understood that the memory device 140 is shown as a memory device in FIG. 1, but this is illustrative and not limiting, and there may be a greater number of memory devices in the exemplary environment 100.

By way of example and not limitation, the memory device 140 may include, but is not limited to, a local memory device, a remote memory device, and a combination thereof. In some examples, the plurality of memory devices in the memory device 140 may include, but are not limited to, a mechanical hard disk HDD, a solid-state drive SSD, etc., and some of the plurality of memory devices may be arranged locally while others can be arranged at a distal end, such as coupled together via a line or network, or the like.

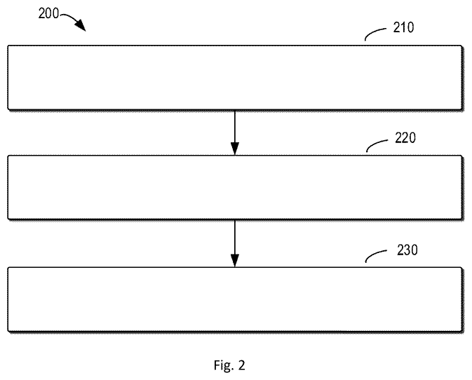

An exemplary environment 100 in which the method and/or process according to examples of the present disclosure may be implemented is described above in connection with FIG. 1. A flowchart of a method 200 for generating a classification model according to examples of the present disclosure will be described below in connection with FIG. 2 The method 200 enables effective consideration of specific or concrete scenarios during the generation of a classification model, thereby improving the flexibility and accuracy of the model, thus improving the quality of data mining. Further, generation of the classification model is based on incremental training to ensure the high efficiency and stability of the model generation process.

At block 210, a plurality of images associated with a target text are acquired by a text-image semantic alignment model, and the target text indicates a target scene. According to an example of the present disclosure, text associated with a target scene may be obtained (hereinafter also referred to as the target text). In some examples, such text may be received by an input device, such as a keyboard and microphone, for example, from a user. Upon receiving the target text, the computing device 130 may parse the target text and, on this basis, may retrieve a corresponding plurality of images from the image set 120 through a text-to-image semantic alignment model.

According to an example of the present disclosure, through a text-image semantic alignment model, text semantics can be extracted from the target text and a semantic level matching and correspondence between the target text and an image of the image set is performed to find an image associated with the target text. With such text-image semantic alignment processing, a better understanding of the semantic relationship between the text and the image is achieved, and accurate image feedback is given. In the following, the text-image semantic alignment processing in accordance with the examples of the present disclosure will be described in further detail.

At block 220, an image sample set comprising an image sample labeled with a category is created by determining the category of each image of the plurality of images. According to an example of the present disclosure, a label processing may be performed on a plurality of images associated with the target text acquired at 210 such that each of these images is automatically assigned a corresponding category label, wherein such a label assignment process may be based on computer vision techniques for the images. In the following, the image sample set generation process in accordance with examples of the present disclosure will be further described in detail.

At block 230, based on the image sample set, a classification model is generated for the target scene, wherein the generation of the classification model is based on a pre-trained model utilizing linear probing. According to the examples of the present disclosure, based on the image sample set generated at 220 including an image sample with a category label, the parameter set of the classification model can be adjusted to generate a classification model for a particular or specific scene, wherein the generation of the classification model is based on a pre-trained model utilizing linear probing. In other words, the classification model has been pre-trained prior to generation.

Linear probing is a model fine tuning technique. Through linear probing, optimization and tuning can be done for a particular task based on the pre-trained model, and such an adjustment process involves only a portion of the model. According to an example of the present disclosure, in the process of linear probing, the parameters of the model may be fine-tuned for the target scene indicated by the target text based on a model pre-trained for classification using a large amount of data, where such fine-tuning only involves a small number of layers of the model or a small portion of the parameter set. This allows for greater utilization of the pre-trained results of the model and eliminates the need to retrain the whole model, thereby saving computing resources and time. At the same time, by fine-tuning a small number of layers or a small portion of the parameters of the model, we can improve the adaptability of the model to specific or concrete scenarios on the basis of maintaining the stability of the model.

The method for generating a classification model according to examples of the present disclosure enables the automatic formation of corresponding sample sets of labeled samples for supervised or semi-supervised learning for specific scenario needs indicated by the text, and model customization for specific scenario needs and quick provision of a classification model with improved flexibility and accuracy while maintaining model stability at the same time. The various examples of the classification model generation process according to examples of the present disclosure will be described in further detail below.

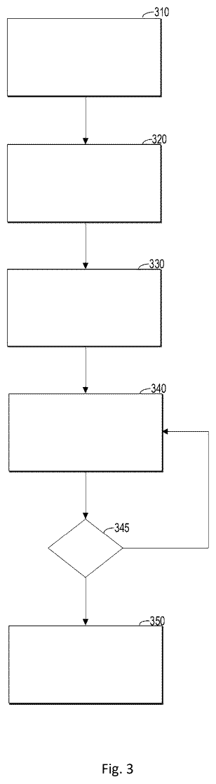

FIG. 3 illustrates a diagram of a classification model generation process 300 according to examples of the present disclosure. As exemplified in FIG. 3, the classification model generation process 300 may include a search sub-process 310, a data set generation sub-process 320, a training sub-process 330, a test sub-process 340, and a prediction sub-process 350. The classification model generation process 300 and its sub-process may be abstracted as a classification model generation unit and corresponding sub-units (e.g., search sub-units, data set generation sub-units, etc.) for a sub-process, and the unit and sub-units may be software-based components or systems to generate the classification model, and may be run on a computing capable device (e.g., computing device 130).

According to an example of the present disclosure, at the search sub-process 310, a text description of a scene of interest may be entered and a plurality of images corresponding to the scene of interest in the image set 120 may be searched based on the text description, wherein the image set 120 may include the image captured by a visual sensor on the vehicle 110 as discussed above, and may also include, for example, an original image extracted from sequence data, and the like. It will be understood that examples of the present disclosure do not limit the acquisition of images in the image set 120. Through the multi-modal search sub-process 310, the image set can be crudely screened with text information for a scene of interest. In the following text, the search sub-process 310 according to examples of the present disclosure will be described in further detail.

According to an example of the present disclosure, at the data set generation sub-process 320, a corresponding category label may be automatically assigned for each of a plurality of images searched at 310 corresponding to the target scene. For example, for a scene of a tunnel inlet, each image may be assigned a label for an inlet or a non-inlet, or for a scene of a tunnel environment, each image may be assigned a label for an inlet, an outlet, interior, or the like. In some examples, such automated label processing may be based on a folder. It will be understood that the examples of the scenes and categories described herein are for purposes of ease of comprehension and ease of illustration only and are not limiting. The data set generation sub-process 320 enables the generation of an image sample set of image samples labeled with a category for subsequent training and testing. In the following, the data set generation sub-process 320 according to examples of the present disclosure will be described in further detail.

According to examples of the present disclosure, at the training sub-process 330, the classification model may be trained using a portion of the image sample set generated at 320. Since such an image sample set is for a target scene, through this training sub-process 330, the trained classification model may have adaptability for the target scene and be more adapted to the target scene, resulting in improved accuracy. In other words, the model has been pre-trained using a large amount of data and then parameter fine-tuning is made during the training for the target scene indicated by the target text. Through this training sub-process 330, the pre-training results of the model can be more fully utilized, and only a small number of layers or a small portion of the parameters of the model need to be fine-tuned, saving computational resources and time with high precision while maintaining model stability. In the following, the training sub-process 330 according to examples of the present disclosure will be described in further detail.

According to an example of the present disclosure, at the test sub-process 340, another portion of the image sample set generated at 320 may be utilized to test the classification model trained at 330 to evaluate the training effect. In some examples, the precision threshold can be predefined and the performance of the trained classification model can be tested according to the predefined precision threshold. For example, at 345, if the model precision meets the expectations indicated by the predefined precision threshold, the classification model is utilized for subsequent prediction process. Conversely, if the precision of the model does not meet the expectations, further adjustment of the classification model is required until the expectations are met. In some examples, the classification model generation process 300 returns to the training sub-process 330 for retraining in response to a model precision that fails to meet the expectations. In the following, the test sub-process 340 according to examples of the present disclosure will be described in further detail.

According to examples of the present disclosure, at the prediction sub-process 350, the prediction may be performed using a trained classification model validated by the test sub-process 340 for determining which category the input image belongs to. In some examples, input images associated with a target scene may be received and input images may be input into a trained classification model to predict the categories that each input image belongs to under that target scene. In this way, the category to which each input image belongs can be determined by the generated classification model and the sorted input image is output. These sub-processes described in FIG. 3 will be described in further detail below.

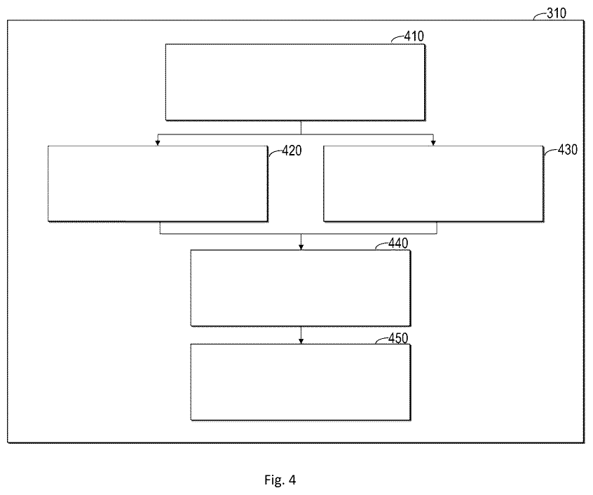

FIG. 4 illustrates a diagram of search processing for the image set 120 according to examples of the present disclosure. As discussed above at 310, a plurality of images associated with a target text are acquired by a text-image semantic alignment model, where the target text indicates a target scene. This search processing of the image set 120 allows the image set 120 to be crudely screened to retrieve a plurality of images associated with a scene of interest. Although a small amount of noise may be present in the retrieved plurality of images, such a crude screening has filtered out the vast majority of irrelevant data, thereby helping to improve training of the classification model and reduce the load of subsequent processing.

In some examples, acquiring the plurality of images associated with the target text may include extracting a text feature from the target text with a text encoder and extracting an image feature for each image in the image set 120 with an image encoder. The similarity between the extracted text feature and the extracted image feature may then be calculated, and a predetermined number of images in the image set for which the calculated similarity of the image feature is greater than a predetermined similarity threshold are selected.

In some examples, the above-described text-image semantic alignment model may include a pre-trained model learning with a text-image comparison, and the text encoder and image encoder may be pre-trained text encoder and image encoder included in the pre-trained model learning with a text-image comparison. The text-image semantic alignment model enables processing text and images together, and by joint learning of the images and text, the semantic associations therebetween are captured, thereby enabling text-based image classifications. In some examples, the text-image semantic alignment model may include a Contrastive Language-Image Pre-training (CLIP) model.

As shown in FIG. 4, at 410, the text-image semantic alignment model is loaded. At 420, a text description of a scene of interest is obtained and the text feature is extracted therefrom by the text encoder. At 430, an original image is obtained and the image feature is extracted therefrom by the image encoder. At 440, the similarity between the extracted text feature and the extracted image feature is calculated. At 450, a predetermined number of images are obtained based on the calculated similarity. For example, the first 100 images having a calculated similarity of their image features that is greater than a predetermined similarity threshold are obtained. It will be understood that the example of the predetermined number described herein is for ease of understanding and ease of illustration only and is not limiting.

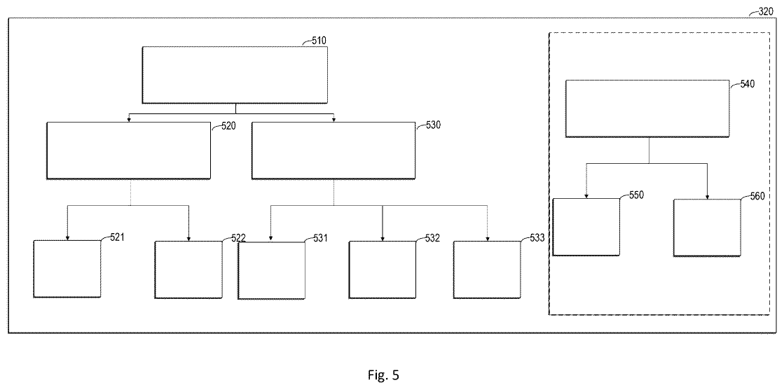

FIG. 5 illustrates generation processing of an image sample set according to examples of the present disclosure. According to an example of the present disclosure, to automatically assign a corresponding category label to each of the plurality of images that are searched corresponding to a target scene, images of the same category may be placed into the same folder based on the image processing model, where examples of the image processing model may include, but are not limited to, a transformer, etc., and the image processing model may be a pre-trained model. It will be understood that the examples of the image processing model described herein are for purposes of ease of comprehension and ease of illustration only and are not limiting, and that examples of the present disclosure may also employ more different image processing models to perform generation processing of the image sample set.

As shown in FIG. 5, at 510, a plurality of images that are searched are sorted into different folders. At 520, a dichotomous label generation is performed, i.e., a positive sample category label or a negative sample category label is assigned to each of the plurality of images searched, that is, determining whether each image sample is a positive sample or a negative sample. At 521, an image sample assigned with a positive sample category label is placed into a positive sample folder and at 522, an image sample assigned with a negative sample category label is placed into a negative sample folder.

At 530, a multi-classification label generation is performed, i.e., a corresponding category label of the plurality of category labels is assigned to each of the plurality of images searched, that is, a sample category of each image sample is determined. Next, a trinary label generation is used as an example of the multi-classification label generation, and this is not intended to be limiting but for purposes of ease of comprehension and ease of description only. At 531, an image sample assigned with, for example, a sample category A label, is placed into a sample category A folder. At 532, an image sample assigned with a sample category B label is placed into a sample category B folder, and at 533, an image sample assigned with a sample category C label is placed into a sample category C folder, etc.

In order for the image to be subsequently input into the model to have a format adapted to the model, the image may be pre-processed. According to an example of the present disclosure, each image in the image set 120 may be pre-processed to adapt the input size of the classification model. The pre-processing used may include, but is not limited to, adjusting the size and centered cropping, etc. As shown in FIG. 5, at 540, an image to be processed is input. At 550, the size of the image is adjusted and at 560, the image is centrally cropped. By way of example and not limitation, the pre-processed image may have a format of 224*224 or 336*336 pixels.

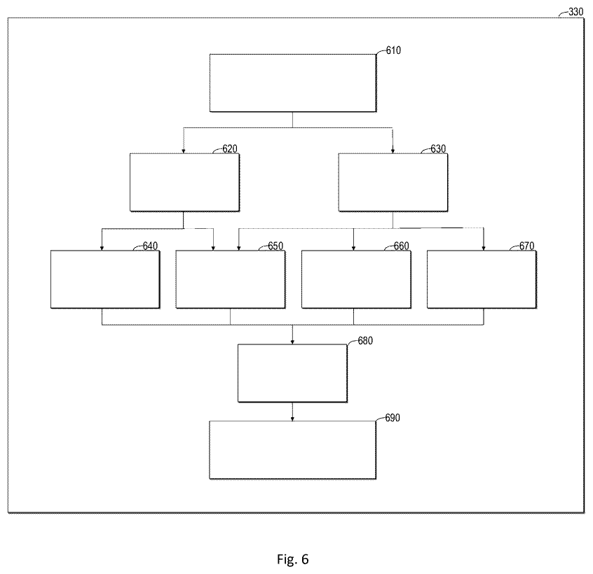

FIG. 6 illustrates training processing of a classification model according to examples of the present disclosure. According to an example of this disclosure, the classification model to be trained may include a linear probing model learning with text-image comparison. In some examples, such examples of a linear probing model learning with text-image comparison may include a pre-trained CLIP linear probing model and may include two fully linked layers for achieving a balance between speed and precision. It should be understood that, in order to suit various actual situations and specific needs, the classification model to be trained may also include other different models, and the model may include more or less fully linked layers, which the present disclosure does not limit.

During training processing for the classification model, an image sample set as generated above may be used. The amount of data used during training and testing is relatively small compared to traditional methods, for example, only dozens of data samples are needed for each category, due to the linear probing model learning with text-image comparison. The test image sample set may be larger to test the robustness and generalization ability of the classification model. It will be understood that more data is also feasible and that a larger set of image samples can be achieved by way of data enhancements. In other words, the classification model generation process 300 according to examples of the present disclosure may be supervised learning or may be semi-supervised learning.

In some examples, the image sample set may include a training image sample set having a first number of image samples and a test image sample set having a second number of image samples, wherein the first number is less than the second number. It will be understood that the numbers of training image samples and test image samples in the image sample set described herein are merely exemplary and other different numbers may be employed.

According to an example of the present disclosure, in the case of sorting the image samples in the image sample set into two categories (i.e., positive sample category and negative sample category), the classification model can be trained using a loss function of a difference between a predicted classification result and a corresponding category label for each image sample in the image training sample set. The loss function is based on a combination of Sigmoid activation function with a binary cross-entropy loss calculation and a focal loss, and a parameter set of the classification model is adjusted by minimizing the loss function. It should be noted that other suitable activation functions are also feasible.

As shown in FIG. 6, at 610, the pre-trained linear probing model learning with text-image comparison is loaded and the system is switched to training mode. At 620, the two classifications as described above are indicated. At 640 and 650, BCEWithlogrtsloss combined with the Sigmoid activation function, as well as focal loss, will be calculated using the binary cross-entropy loss. Because it is a dichotomous classification, there is often an imbalance of categories between positive and negative sample sets. According to an example of the present disclosure, a focal loss may be applied to BCEWithLogits to make the model more focused on examples of difficulty and misclassifications by lowering the weight of simple examples, as shown in Formula (1) below:

$${BCEWithLogits}_{FL} = {α ( 1 - {e}^{- BCEWithLogits} )}^{γ} * BCEWithLogits \qquad ( 1 )$$

where α controls the balance between simple examples and difficult examples. It is the weight that gives more importance to the minority category (positive category) during the training process. The higher the value of α, the greater the weight of the positive category, which facilitates handling classification imbalance by paying more attention to difficult positive samples.

In addition, y is another hyperparameter that controls the rate of loss reduction for well-classified examples. It introduces a modulating factor that can amplify the loss for incorrect classification examples. A higher y value increases the rate of focal loss decline for well-classified examples, thereby emphasizing examples that are more difficult during training. It will be appreciated that, to improve performance, other hyperparameters are also configurable, e.g., number of Epochs, learning rate, batch size, etc.

In this way, applying the focal loss to BCEWithLogits can result in improved BCEWithLogitsFL as described above.

In accordance with examples of the present disclosure, when the image samples in the image sample set are classified into multiple categories (such as, but not limited to, three categories, sample categories A, B and C), the classification model can be trained using a loss function of a difference between a predicted classification result and a corresponding category label for each image sample in the image training sample set. The loss function is based on a cross-entropy loss, a smooth cross-entropy loss, and a focal loss, and a parameter set of the classification model can be adjusted by minimizing the loss function.

As shown in FIG. 6, at 630, the multi-classification conditions described above are indicated, and this will be illustrated below taking trinary classifications as an example without limitation. At 650, 660, and 670, a cross-entropy loss, a smooth cross-entropy loss, and a focal loss will be employed. According to an example of the present disclosure, a cross-entropy loss may first be used to calculate a cross-entropy between a predicted category and a real category. The “hard” labels 0 and 1 may then be replaced with a smooth cross-entropy loss, such as a value that is slightly smoothed (such as, 0.1 and 0.9).

In some examples, a tensor may be created, wherein a smaller value is assigned for each category except the target category. The target category may be assigned a higher probability and the remaining probability mass is allocated among the other categories. Next, a standard cross-entropy loss can be calculated without label smoothing. A label smoothing effect is applied by element-wise multiplication between the loss and the smoothed label, such that the loss contribution of the incorrectly predicted category based on the smoothed label is reduced. The losses are summed and the tensor of smoothing loss for each sample is obtained. Finally, the average of these losses is returned as the final smoothing loss value. In this way, by introducing label smoothing, the model can be facilitated to become more robust in prediction. Additionally, or alternatively, the focal loss may also be applied to multi-classification cases, as shown in Formula (2) below:

$${CE}_{FL} = {α ( 1 - {e}^{- CE} )}^{γ} * CE \qquad ( 2 )$$

wherein α and y may be the same or similar to those discussed above. Using the cross-entropy of focal loss can further converge the loss for higher accuracy, especially for complex multi-classification tasks such as scenario classification for a special-shaped truck. By utilizing the cross-entropy and smooth cross-entropy of focus loss, the final loss value can be reduced by one order of magnitude.

By way of a loss strategy as described above, at 680, linear probing training may be conducted and at 690, a trained linear probing model learning with text-image comparison is saved. Training processing of the classification model in accordance with examples of the present disclosure makes training time for the model very fast as only the final classification layer, for example, is trained for the target scene. In particular, training processing of examples of the present disclosure typically only requires, for example, a few minutes as compared to weeks of traditional methods, which in turn enables rapid iteration of the classification model to find the optimum parameter.

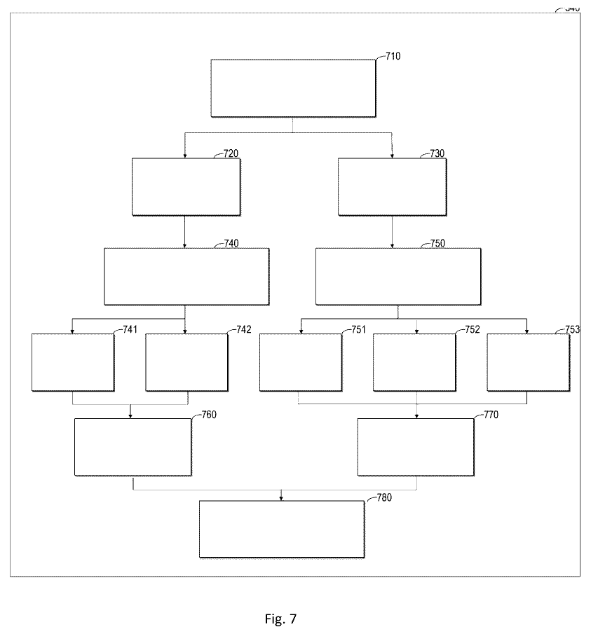

FIG. 7 illustrates test processing of a classification model according to examples of the present disclosure. According to an example of the present disclosure, a model precision score for the classification model is obtained by testing the generated classification model with a test image sample set and the acquired model precision score is compared to a predefined precision threshold.

As shown in FIG. 7, at 710, the linear probing model trained for the target scene, learning with text-image comparison, is loaded and the system is switched to a test mode. At 720, the test for dichotomous linear probing is indicated, and at 730, the test for multi-classification linear probing is indicated. The test results are compared to the label at 740 and 750. In the case of dichotomous linear probing, at 741, the image sample with a test value greater than or equal to 0 is sorted into the positive sample category as a positive sample when the value indicated by the label is 0, and at 742, the image sample with a test value less than or equal to 0 is sorted into the negative category as a negative sample when the value indicated by the label is 1. Similarly, in the case of multi-classification probing, at 751, 752, and 753, the image samples are sorted into respective sample categories based on the test value and the value indicated by the label, such as sample categories A, B and C. At 760 and 770, the precision of the model on the test image sample set is calculated and the model precision score is output. In some examples, for example, the model precision score is determined based on a ratio of correctly sorted image samples to the total samples. At 780, the test results are output.

According to examples of the present disclosure, in response to the model precision score resulting from the above-described test processing being less than the predetermined precision threshold, the image sample set may be updated by adding additional image samples to the image sample set, wherein the additional image samples are associated with a long tail scene, and the classification model is retrained with the updated image sample set. In this way, when the training effect is not ideal, retraining can be performed for the scene with poor training effect by improving the sample quality to obtain improved accuracy. It will be appreciated that sample quality may also be improved by removing noise and outliers, etc.

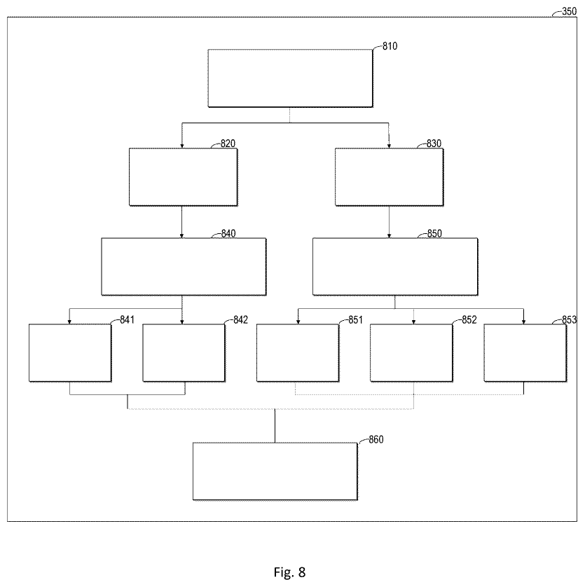

FIG. 8 illustrates prediction processing of a classification model according to examples of the present disclosure. According to an example of the present disclosure, an input image associated with the target scene may be received, the category of each input image is determined by the generated classification model, and the sorted input image is output. The linear probing model trained for a target scene according to an example of the present disclosure, learning using text-image comparison, can provide an accurate classification for the input image of the target scene. In some examples, the sorted input images may be manually reviewed and further labeled and may then be incorporated into the image sample set to form a closed loop for processing for subsequent functions.

As shown in FIG. 8, at 810, a tested linear probing model learning with text-image comparison trained for a target scene is loaded and the system is switched to a prediction mode. At 820, the prediction is indicated for the dichotomous linear probing, and at 830, the prediction is indicated for the multi-classification linear probing. At 840 and 850, inference features are acquired. In the case of dichotomous linear probing, at 841, the image sample is sorted into the positive sample category as a positive sample when the predicted value is greater than 0 and at 842, the image sample is sorted into the negative sample category as a negative sample when the predicted value is less than 0. Similarly, in the case of multi-classification probing, at 851, 852, and 853, the image samples are sorted into respective sample categories based on the predicted values, such as sample categories A, B, and C. At 860, a predicted image for the target scene and a category thereof are output.

FIG. 9 shows a schematic diagram of an apparatus 900 for generating a classification model according to examples of the present disclosure. The apparatus 900 may comprise multiple units or modules for performing the corresponding steps in the method 200 as discussed in FIG. 2. As shown in FIG. 9, the apparatus 900 comprises: The image acquisition module 910 is configured to acquire a plurality of images associated with a target text through a text-image semantic alignment model, the target text indicating a target scene; the sample set generation module 920 is configured to generate an image sample set including an image sample labeled with a category by determining which category each of the plurality of images belongs to; and the model generation module 930 is configured to generate the classification model for the target scene based on the image sample set, wherein the generation of the classification model is based on a pre-trained model using linear probing.

In some examples, the image acquisition module 910 is further configured to: extract a text feature from the target text using a text encoder; extract an image feature for each image in the image set using an image encoder; calculating a similarity between the extracted text feature and the extracted image feature; and select a predetermined number of images in the image set for which the calculated similarity of the image feature is greater than a predetermined similarity threshold.

In some examples, the image set may include images captured by one or more vision sensors on a vehicle, and the apparatus 900 may also include a pre-processing module, configured to: adapt an input size of the classification mold by performing pre-processing on each image of the image set, where the pre-processing includes adjusting a size and centered cropping.

In some examples, the classification model may learn based on a comparison and include two fully linked layers; and the image sample set may include a training image sample set having a first number of image samples and a test image sample set having a second number of image samples, the first number being less than the second number.

In some examples, the number of categories may include 2 and the categories may include a positive sample category and a negative sample category, and the model generation module 930 may be further configured to: train the classification model using a loss function of a difference between a predicted classification result and a corresponding category label for each image sample in the image training sample set, the loss function based on a combination of the Sigmoid activation function with a binary cross-entropy loss calculation and a focal loss; and adjust a parameter set of the classification model by minimizing the loss function.

In some examples, the number of categories may include three or more, and the model generation module 930 may be further configured to: train the classification model using a loss function of a difference between a predicted classification result and a corresponding category label for each image sample in the image training sample set, the loss function based on a cross-entropy loss, a smooth cross-entropy loss, and a focal loss; and adjust a parameter set of the classification model by minimizing the loss function.

In some examples, the apparatus 900 may further include a test module, which is configured to: test the generated classification model using the test image sample set to obtain a model precision score for the classification model; and compare the acquired model precision score to a predefined precision threshold.

In some examples, the apparatus 900 may further comprise a retraining module configured to, in response to the model precision score being less than the predefined precision threshold, update the image sample set by adding additional image samples to the image sample set, wherein the additional image samples are associated with a long tail scene; and retrain the classification model with the updated image sample set.

In some examples, the target scene may include a tunnel inlet and the category may include an inlet and a non-inlet; or the target scene may include a tunnel environment and the category may include an inlet, an outlet, an interior, and others.

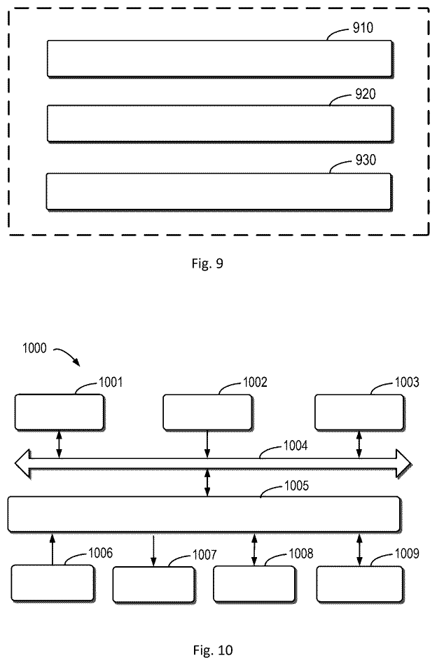

FIG. 10 illustrates a schematic block diagram of an exemplary device 1000 that may be used to implement the examples of the present disclosure. As shown in the figure, the device 1000 comprises a central processing unit (CPU) 1001, which can execute various appropriate actions and processing based on computer program instructions stored in a read-only memory (ROM) 1002 or computer program instructions loaded onto a random access memory (RAM) 1003 from a storage unit 1008. Various programs and data required for the operation of the device 1000 may also be stored in the RAM 1003. The CPU 1001, the ROM 1002, and the RAM 1003 are interconnected through a bus 1004. An input/output (I/O) interface 1005 is also connected to the bus 1004.

A plurality of components in the device 1000 are connected to the I/O interface 1005, comprising: an input unit 1006, such as a keyboard and mouse; an output unit 1007, such as various types of display and speaker; a storage unit 1008, such as a disk and optical disc; as well as a communication unit 1009, such as a network interface card, modem, and wireless communication transceiver. The communication unit 1009 allows the device 1000 to exchange information/data with other devices through computer networks such as the Internet and/or various telecommunication networks.

The various processes and processing described above, such as the method 200, the process 300 and sub-processes thereof, may be executed by the processing unit 901. For example, in some examples, the method 200 and the process 300 and sub-processes thereof may be realized as a computer software program that is tangibly contained in a machine-readable medium, such as the storage unit 1008. In some examples, part or all of the computer program may be loaded and/or installed onto the device 1000 through the ROM 1002 and/or the communication unit 1009. When the computer program is loaded into the RAM 1003 and executed by CPU 1001, one or more actions of the method 200 and the process 300 and sub-processes thereof described above may be executed. According to an example of the present disclosure, provided is a vehicle that can include the apparatus 900 as described above for performing various aspects of the present disclosure.

The present disclosure may be a method, an apparatus, an electronics device, a vehicle, a computer-readable storage medium, and/or a computer program product. The computer program product may comprise a computer-readable storage medium loaded with computer-readable program instructions for performing various aspects of the present disclosure.

The computer-readable storage medium may be a tangible device that maintains and stores instructions used by instruction execution devices. The computer-readable storage medium, for example, may be—but is not limited to—an electrical storage device, a magnetic storage device, an optical storage device, an electromagnetic storage device, a semiconductor memory device, or any suitable combination of the above. More specific examples of the computer-readable storage medium (a non-exhaustive list) comprise: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, such as a punch card and a protrusion structure in grooves with instructions stored thereon, as well as any suitable combinations of the above. The computer-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The computer-readable program instructions described herein may be downloaded to various computing/processing devices from the computer-readable storage medium, or downloaded from networks, such as the Internet, a local area network, a wide-area network and/or a wireless network to external computers or external storage devices. The networks may comprise copper transmission cables, optical fiber transmissions, wireless transmissions, routers, firewalls, switches, gateway computers, and/or edge servers. The network adapter card or network interface in each computing/processing device receives the computer-readable program instructions from the network and forwards the computer-readable program instructions for storage in computer-readable storage medium of each computing/processing device.

The computer program instructions used to perform the operations of the present disclosure may be assembly instructions, instruction set architecture (ISA) instructions, machine instructions, machine-related instructions, microcode, firmware instructions, state set data, or source code or object code written with any combination of one or more programming languages. The programming language includes object-oriented programming languages such as Smalltalk and C++, and conventional procedural programming languages such as “C” languages and similar programming languages. Computer-readable program instructions may be fully executed on the user's computer, partially executed on the user's computer, executed as an independent software package, partially executed on the user's computer and partially executed on a remote computer, or fully executed on a remote computer or server. Where a remote computer is involved, the remote computer may be connected to the user's computer through any type of network, including local area network (LAN) or wide area network (WAN), or it may be connected to an external computer (such as by using an Internet service provider for Internet connection). In some examples, the state information of computer-readable program instructions is used to personalize custom electronic circuits, such as a programmable logic circuit, field-programmable gate array (FPGA) or programmable logic array (PLA), wherein the electronic circuit is capable of executing computer-readable program instructions, thereby achieving the various aspects of the present disclosure.

Various aspects of the present disclosure are described herein with reference to flow charts and/or block diagrams depicting methods, apparatus (systems), and computer program products according to the examples of the present disclosure. It should be understood that every block in the flow charts and/or block diagrams and the combinations of various blocks in the flow charts and/or block diagrams may be implemented by computer-readable program instructions.

These computer-readable program instructions may be provided to general-purpose computers, dedicated computers, or the processing unit of other programmable data processing apparatuses, thereby producing a type of machine, so that these instructions produce an apparatus that implements the function/action stipulated in one or a plurality of blocks in the flow charts and/or block diagrams when executed by computers or processing units of other programmable data processing apparatuses. These computer-readable program instructions may also be stored in a computer-readable storage medium, and these instructions enable computers, programmable data processing apparatuses, and/or other devices to operate in a specific manner. Therefore, the computer-readable media containing instructions comprise a manufactured product that includes instructions for implementing various aspects of the functions/actions specified in one or more blocks in the flow charts and/or block diagrams.

Computer-readable program instructions may also be loaded onto the computer, other programmable data processing apparatuses or other devices to execute a series of operating steps on the computer, other programmable data processing apparatuses or other devices, thereby allowing the instructions executed on the computer, other programmable data processing apparatuses or other devices to implement functions/actions stipulated in one or many blocks in the flow charts and/or block diagrams.

The flow charts and block diagrams in the accompanying drawings show the system architecture, functions and operations that may be implemented based on the systems, methods and computer program products according to the plurality of examples of the present disclosure. Regarding this, every block in the flow charts or block diagrams can represent a part of a module, program section or instructions, wherein the part of the module, program section or instructions contains one or a plurality of executable instructions that are used to implement the stipulated logic function. In some alternative implementations, the occurrence of the function indicated in the blocks may also differ from the sequence indicated in the accompanying drawings. For example, two continuous blocks may actually be substantially performed in a concurrent manner and they may also sometimes be performed in reverse order, depending on the functions involved. It must also be noted that every block in the block diagrams and/or flow charts, as well as combinations of blocks in the block diagrams and/or flow charts may be implemented by dedicated hardware-based systems used to perform the stipulated functions or actions, or implemented by using combinations of dedicated hardware and computer instructions.

The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The selection of terms used in the present description aims to best explain the principles and actual application of the various examples, the technological improvements in the technology in the market, or allow others of ordinary skill in the art to understand the various examples disclosed in the present description.

What is claimed is:

1. A method for generating a classification model, comprising:
acquiring, by a text-image semantic alignment model, a plurality of images associated with a target text, the target text indicating a target scene;
generating an image sample set comprising an image sample labeled with a category by determining to which category each of the plurality of images belongs; and
generating the classification model for the target scene based on the image sample set, wherein the generation of the classification model is based on a pre-trained model using linear probing.

2. The method according to claim 1, wherein acquiring the plurality of images associated with the target text comprises:
extracting a text feature from the target text with a text encoder;
extracting an image feature for each image in the image set with an image encoder;
calculating a similarity between the extracted text feature and the extracted image feature; and
selecting a predetermined number of images in the image set for which the calculated similarity of the image feature is greater than a predetermined similarity threshold.

3. The method according to claim 2, wherein the image set includes images captured by one or more vision sensors on a vehicle, the method further comprising:
adapting an input size of the classification mold by performing pre-processing on each image of the image set,
wherein the pre-processing comprises adjusting a size and centered cropping.

4. The method according to claim 1, wherein:
the classification model learns based on a comparison and includes two fully linked layers; and
the image sample set comprises a training image sample set having a first number of the image samples and a test image sample set having a second number of the image samples, the first number being less than the second number.

5. The method according to claim 4, wherein the number of categories includes two and the category includes a positive sample category and a negative sample category, and
wherein generating the classification model comprises:
training the classification model using a loss function of a difference between a predicted classification result and a corresponding category label for each image sample in the image training sample set, the loss function based on a combination of an activation function with a binary cross-entropy loss calculation and a focal loss; and
adjusting a parameter set of the classification model by minimizing the loss function.

6. The method according to claim 4, wherein the number of categories includes three or more than three, and
wherein generating the classification model comprises:
training the classification model using a loss function of a difference between a predicted classification result and a corresponding category label for each image sample in the image training sample set, the loss function based on a cross-entropy loss, a smooth cross-entropy loss, and a focal loss; and
adjusting a parameter set of the classification model by minimizing the loss function.

7. The method according to claim 5, further comprising:
acquiring a model precision score for the classification model by testing the generated classification model with the test image sample set; and
comparing the acquired model precision score to a predefined precision threshold.

8. The method according to claim 7, further comprising:
in response to the model precision score being less than the predefined precision threshold,
updating the image sample set by adding additional image samples to the image sample set, wherein the additional image samples are associated with a long tail scene; and
retraining the classification model with the updated image sample set.

9. The method according to claim 1, further comprising:
receiving an input image associated with the target scene;
determining, by the generated classification model, the category to which each input image in the input images belongs; and
outputting the sorted input image.

10. The method according to claim 1, wherein:
the target scene comprises a tunnel inlet and the category comprises an inlet and a non-inlet; or
the target scene includes a tunnel environment and the category includes an inlet, an outlet, an interior, and others.

11. An apparatus for generating a classification model, comprising:
an image acquisition module configured to acquire a plurality of images associated with a target text through a text-image semantic alignment model, the target text indicating a target scene;
a sample set generation module configured to generate an image sample set comprising an image sample labeled with a category by determining to which category each of the plurality of images belongs; and
a model generation module configured to generate the classification model for the target scene based on the image sample set, wherein the generation of the classification model is based on a pre-trained model using linear probing.

12. An electronic device comprising:
at least one processor; and
a memory coupled to the at least one processor and having instructions stored thereon, the instructions, when executed by the at least one processor, causing the device to perform the method according to claim 1.

13. A vehicle including the electronic device according to claim 12.

14. A computer-readable storage medium having computer-executable instructions stored thereon, wherein the computer-executable instructions are executed by a processor to implement the method according to claim 1.
